(19) United States
(12) Patent Application Publication
(10) Pub. No.: US 2021/0360218 A1
(43) Pub. Date: Nov. 18, 2021

(54) METHOD FOR RECTIFICATION OF 2D MULTI-VIEW IMAGES AND APPARATUS FOR THE SAME

(71) Applicants: Electronics and Telecommunications Research Institute, Daejeon (KR); SOGANG UNIVERSITY RESEARCH & BUSINESS DEVELOPMENT FOUNDATION, Seoul (KR)

(72) Inventors: Joon Soo KIM, Daejeon (KR); Kug Jin YUN, Daejeon (KR); Jun Young JEONG, Daejeon (KR); Suk Ju KANG, Seoul (KR); Jung Hee KIM, Seoul (KR); Yeo Hun YUN, Seoul (KR)

(73) Assignees: Electronics and Telecommunications Research Institute, Daejeon (KR); SOGANG UNIVERSITY RESEARCH & BUSINESS DEVELOPMENT FOUNDATION, Seoul (KR)

(21) Appl. No.: 17/321,213

(22) Filed: May 14, 2021

(30) Foreign Application Priority Data
May 15, 2020 (KR) 10-2020-0058690

(51) Int. Cl. H04N 13/128; H04N 13/167; H04N 13/282

(52) U.S. Cl. CPC H04N 13/128; H04N 2013/0081; H04N 13/282; H04N 13/167

(57) ABSTRACT

Disclosed herein is a method for rectifying a 2D multi-view image. The method for rectifying a 2D multi-view image according to an embodiment of the present disclosure may include: detecting uniformly the at least one feature point in each region unit distinguished by considering a distribution of feature points of a plurality of input images: removing an error of the least one feature point; determining a corresponding pair for a vertical or horizontal direction of the at least one feature point; by considering an arrangement relationship of the plurality of input images, projecting the at least one feature point onto a projection plane; determining a disparity error for a corresponding pair for the at least one feature point that is projected onto the projection plane; and, by considering the disparity error, performing image rectification based on the at least one feature point.

### CROSS REFERENCE TO RELATED APPLICATION

The present application claims priority to a K.R. application 10-2020-0058690, filed May 15, 2020, the entire contents of which are incorporated herein for all purposes by this reference.

### BACKGROUND OF THE INVENTION

### Field of the Invention

The present disclosure relates to a method and apparatus for rectifying a multi-view image and, more particularly, to a method and apparatus for processing rectification of an image by using a feature point of a multi-view image.

### Description of the Related Art

A multi-view camera apparatus is used which is configured to take an image from different views. Images are taken simultaneously through cameras installed in a structure (e.g., rig), in which a plurality of cameras may be fixed and mounted, and a synthesized image is constructed by rectifying the taken images.

A multi-view camera apparatus should synchronize images being taken. As each camera takes an image at different position, geometrical distortion should be corrected. However, as a multi-view camera apparatus corrects a mutual geometrical relation by considering a physical element, it has a disadvantage of requiring a lot of computational complexity.

### SUMMARY

Moreover, recent advances in various display technologies capable of outputting virtual reality (VR) and in multi-core technology result in the emergence of omnidirectional camera-related technology that may include information on the real world.

As a omnidirectional camera, unlike a single camera, is capable of expressing every information around the camera into an image, it may be conveniently used to reconstruct a three-dimensional space later. That is, when image information is obtained through cameras present at different positions, as an image with disparity in X-axis or Y-axis direction according to a position of camera may be obtained, a omnidirectional camera may be used to infer depth information, Accordingly, it is possible to reconstruct 3D space information from 2D images. Herein, in order to detect 3D space information (e.g., depth map), a rectification operation for an obtained image is required.

In multi-view camera arrangement, as an error occurs physically on an optical axis of camera, there is a disadvantage that 3D space information is not accurately detected. Especially, when a multi-view camera apparatus is extended to a structure of 2D arrangement, a lot of images may be obtained at the same time. However, when an optical axis of images thus obtained is not aligned, it is not possible to accurately detect 3D space information.

A technical object of the present disclosure is to provide a method and apparatus for conveniently rectifying images obtained from a multi-camera structure with a normalized physical location.

Another technical object of the present disclosure is to provide a method and apparatus for rectifying an image taken by a multi-camera apparatus that is two-dimensionally arranged.

Yet another technical object of the present disclosure is to provide a method and apparatus for quickly and accurately rectifying an image taken by a multi-camera apparatus that is two-dimensionally arranged.

The technical objects of the present disclosure are not limited to the above-mentioned technical objects, and other technical objects that are not mentioned will be clearly understood by those skilled in the art through the following descriptions.

According to one aspect of the present disclosure, a method for rectifying a 2D multi-view image may be provided. The method may include: detecting uniformly at least one feature point in each region unit distinguished by considering a distribution of feature points of a plurality of input images; removing an error of the least one feature point; determining a corresponding pair for a vertical or horizontal direction of the at least one feature point; by considering an arrangement relationship of the plurality of input images, projecting the at least one feature point onto a projection plane; determining a disparity error for a corresponding pair for the at least one feature point that is projected onto the projection plane; and, by considering the disparity error, performing image rectification based on the at least one feature point.

According to another aspect of the present disclosure, an apparatus for rectifying a 2D multi-view image may be provided. The apparatus may include: a feature point detection unit configured to uniformly detect at least one feature point in each region unit distinguished by considering a distribution of feature points of a plurality of input images; an Outlier remover (removing unit) configured to remove an outlier of the least one feature point; a disparity error monitoring unit configured to confirm a corresponding pair for a vertical or horizontal direction of the at least one feature point and to confirm a disparity error for a corresponding pair for the at least one feature point that is projected onto a projection plane by considering an arrangement relationship of the plurality of input images; and, an image rectifier (rectification unit) configured to perform image rectification based on the at least one feature point by considering the disparity error.

The features briefly summarized above with respect to the present disclosure are merely exemplary aspects of the detailed description below of the present disclosure, and do not limit the scope of the present disclosure.

According to the present disclosure, a method and apparatus for conveniently rectifying images obtained from a multi-camera structure with a normalized physical location may be provided.

According to the present disclosure, a method and apparatus for rectifying an image taken by a multi-camera apparatus that is two-dimensionally arranged may be provided.

Also, according to the present disclosure, a method and apparatus for quickly and accurately rectifying an image taken by a multi-camera apparatus that is two-dimensionally arranged may be provided.

Effects obtained in the present disclosure are not limited to the above-mentioned effect, and other effects not mentioned above may be clearly understood by those skilled in the art from the following description.

### BRIEF DESCRIPTION OF THE DRAWINGS

FIGS. 1A to 1D are views illustrating various camera arrangement structure environments to which a rectification apparatus of 2D multi-view images according to an embodiment of the present disclosure is applied.

FIG. 2 is a block diagram illustrating a configuration of a rectification apparatus of 2D multi-view images according to an embodiment of the present disclosure.

FIG. 3 is a view illustrating a distribution of feature points of an input image used in a rectification apparatus of 2D multi-view images according to an embodiment of the present disclosure.

FIG. 4A and FIG. 4B are views illustrating locations of cameras that are rectified by considering a distance constraint between cameras in a rectification apparatus of 2D multi-view images according to an embodiment of the present disclosure.

FIG. 5A and FIG. 5B are views illustrating corresponding pairs of feature points that are managed by a rectification apparatus of 2D multi-view images according to an embodiment of the present disclosure.

FIG. 6 is a flowchart illustrating an order in a method for rectifying 2D multi-view images according to an embodiment of the present disclosure.

FIG. 7 is a block diagram illustrating a computing system implementing a method and apparatus for rectifying 2D multi-view images according to an embodiment of the present disclosure.

### DETAILED DESCRIPTION

Hereinbelow, exemplary embodiments of the present disclosure will be described in detail with reference to the accompanying drawings such that the present disclosure can be easily embodied by one of ordinary skill in the art to which this invention belongs. However, the present disclosure may be variously embodied, without being limited to the exemplary embodiments.

In the description of the present disclosure, the detailed descriptions of known constitutions or functions thereof may be omitted if they make the gist of the present disclosure clear. Also, portions that are not related to the present disclosure are omitted in the drawings, and like reference numerals designate like elements. In the present disclosure, when an element is referred to as being “coupled to”, “combined with”, or “connected to” another element, it may be connected directly to, combined directly or coupled directly to another element or be connected to, combined directly with, or coupled to another element, having the other element intervening therebetween. Also, it should be understood that when a component “includes” or “has” an element, unless there is another opposite description thereto, the component does not exclude another element but may further include the other element.

In the present disclosure, the terms “first”, “second”, etc. are only used to distinguish one element, from another element. Unless specifically stated otherwise, the terms “first”, “second”, etc. do not denote an order or importance. Therefore, a first element of an embodiment could be termed a second element of another embodiment without departing from the scope of the present disclosure. Similarly, a second element of an embodiment could also be termed a first element of another embodiment.

In the present disclosure, components that are distinguished from each other to clearly describe each feature do not necessarily denote that the components are separated. That is, a plurality of components may be integrated into one hardware or software unit, or one component may be distributed into a plurality of hardware or software units. Accordingly, even if not mentioned, the integrated or distributed embodiments are included in the scope of the present disclosure.

In the present disclosure, components described in various embodiments do not denote essential components, and some of the components may be optional. Accordingly, an embodiment that includes a subset of components described in another embodiment is included in the scope of the present disclosure. Also, an embodiment that includes the components described in the various embodiments and additional other components are included in the scope of the present disclosure.

Hereinafter, embodiments of the present disclosure will be described with reference to the accompanying drawings.

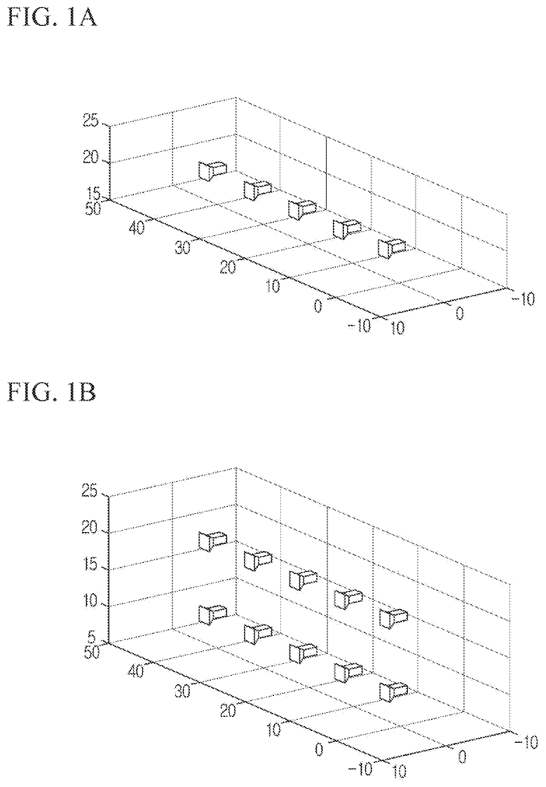

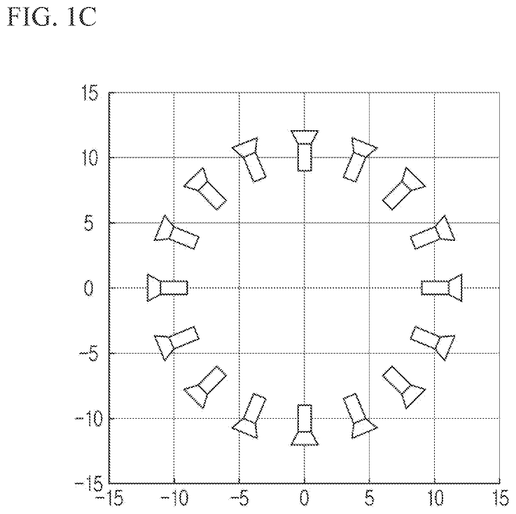

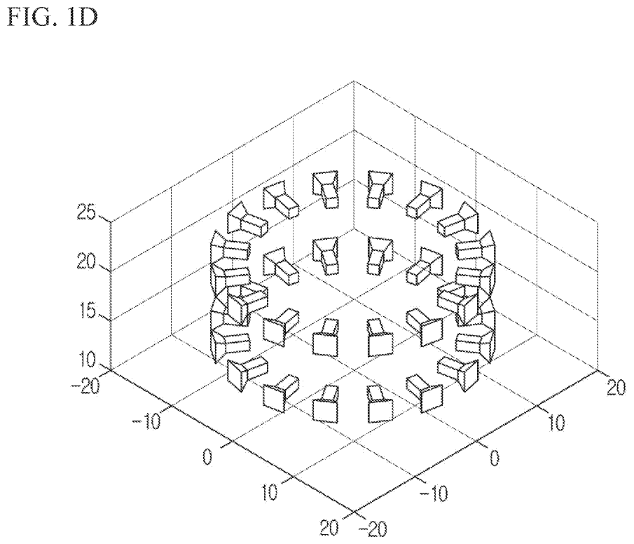

FIGS. 1A to 1D are views illustrating various camera arrangement structure environments to which a rectification apparatus of 2D multi-view images according to an embodiment of the present disclosure is applied.

As shown in FIG. 1A and FIG. 1B, when a multi-view image is obtained in an environment of camera apparatus that is arranged in one dimension, image rectification may be performed through a process in which image planes of cameras corresponding to a plurality of input images respectively are transformed to a shared plane, or image rectification may be performed through a baseline arrangement of cameras corresponding to a plurality of input images respectively.

However, as shown in FIG. 1C and FIG. 1D, in a camera arrangement structure environment that is constructed in two dimensions, it is difficult to perform image rectification by applying a method used in an environment of camera apparatus that is arranged in one dimension. Specifically, ideal cameras should be placed on a 2D plane. As a plane is composed of 3 points unlike a straight line, various candidate planes may be made according to which camera locations are to be combined, and it is not clearly determined which of the locations is a good plane. Thus, it is difficult to apply a plane to a 2D arrangement stricture.

In consideration of the above-described problem, as a rectification apparatus of 2D multi-view images according to an embodiment of the present disclosure detects a corresponding pair of feature points between neighboring cameras, a corresponding pair of feature points may be easily detected. Especially, as a rectification apparatus of 2D multi-views according to an embodiment of the present disclosure does not detect a feature point that is commonly detected in every camera, it may produce an advantageous effect that a corresponding pair of feature points may be determined relatively quickly and conveniently. Furthermore, as a rectification apparatus of 2D multi-views according to an embodiment of the present disclosure determines a corresponding pair of feature points based on neighboring cameras, it may produce an advantageous effect that a corresponding pair of feature points may be conveniently determined for an input image that is obtained through a camera system with circular arrangement structure as illustrated in FIG. 1D. Thus, a rectification apparatus of 2D multi-view images according to an embodiment of the present disclosure may realize a rectified image for images that are obtained from various structures.

Also, a rectification apparatus of 2D multi-view images according to an embodiment of the present disclosure uniformizes a distribution of feature points detected from an input image and performs an operation of removing an erroneous corresponding pair of feature points, thereby realizing consistent image rectification.

Also, a rectification apparatus of 2D multi-view images according to an embodiment of the present disclosure minimizes a disparity error by dividing corresponding pairs of feature points, which are detected by considering a physical position of a camera, into corresponding pairs of x-axis direction and corresponding pairs of y-axis direction, thereby constructing a rectified image for input images obtained from a 2D arrangement camera system structure.

Also, in order to compensate a camera position and error that are likely to occur when arranging actual cameras, a rectification apparatus of 2D multi-view images according to an embodiment of the present disclosure reflects camera position information or error information using a camera parameter, thereby realizing the creation of more accurate 3D spatial information.

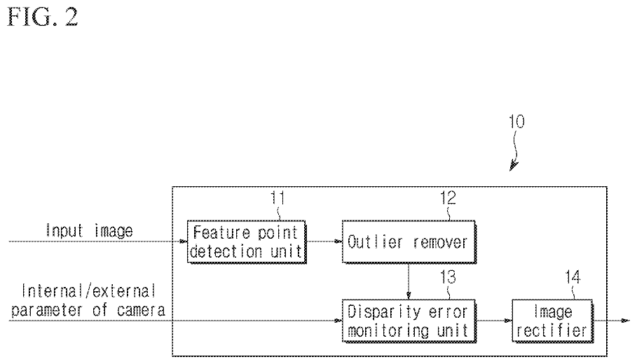

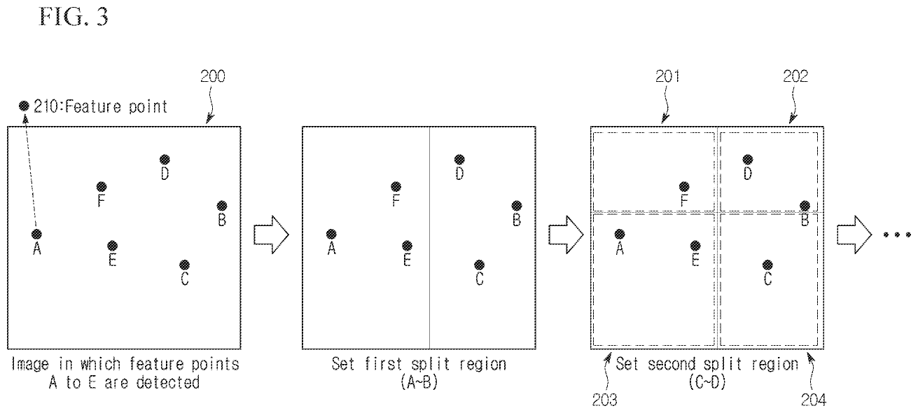

FIG. 2 is a block diagram illustrating a configuration of a rectification apparatus of 2D multi-view images according to an embodiment of the present disclosure.

Referring to FIG. 2, a rectification apparatus of 2D multi-view images 10 according to an embodiment of the present disclosure may include a feature point detection unit 11, an Outlier remover 12, a disparity error monitoring unit 13, and an image rectifier 14.

The feature point detection unit 11 may detect at least one feature point from each of a plurality of input images. Herein, a plurality of input images may be images that are obtained from each of a plurality of cameras. Detection of a feature point may be performed based on the speed-up robust feature (SURF) method. For example, the feature point detection unit 11 may construct an integral image through the operation of Equation 1 below and may detect a feature point by calculating an extreme value through a Hessian matrix for an integral image. Although an embodiment of the present disclosure illustrates a method for detecting a feature point, the present disclosure is not limited to the embodiment and the method for detecting a feature point may be modified in various ways.

$${II}_{\sum } ( x , y ) = {\sum }_{i = 0}^{i \leq x} {\sum }_{j = 0}^{j \leq y} I ( i , j ) \qquad [ Equation 1 ]$$

In Equation 1, I (x,y) means a pixel value for a coordinate of an image and a coordinate of x and y within an image.

Especially, the feature point detection unit 11 may detect uniformly feature points in a plurality of regions by considering a distribution of feature points in an input image,

Specifically, the feature point detection unit 11 may perform sampling so that feature points detected in an input image are distributed uniformly in an image. As described above, as feature points 210 are detected based on an extreme value of Equation 1 of an image, they may be distributed locally intensively in a specific region of an input image 200. When considering only feature points that are locally intensively distributed in an input image, different rectification errors may occur according to a distribution of feature points. In order to improve this, the feature point detection unit 11 needs to process so that feature points are uniformly distributed over a whole area of image. That is, in order to select uniformly some of detected feature points 210 in an image, the feature point detection unit 11 may split the input image 200 into predetermined regions using a partitioning algorithm (e.g., k-d tree algorithm) and then may sample a predetermined number of feature points in each of split regions 201, 202, 203 and 204. For example, the feature point detection unit 11 may divide an input image into preset M regions sequentially from a point with a largest disparity based on detected feature points, detect each feature point in split regions 201, 202, 203 and 204 respectively, and finally detect M feature points that are uniformly distributed.

The Outlier remover 12 may confirm whether feature points correspond to each other between input images (e.g., input images obtained from neighboring cameras) in which an overlap occurs at least for some regions. For example, the Outlier remover 12 may construct a corresponding pair of feature points using feature points detected in a uniform distribution and perform an operation of removing an error or outlier of corresponding pairs through the operation of Equation 2 below.

$${I}_{inlier} = \{ \begin{matrix}i ∈ {I}_{inlier} & if \vert {D}_{i} - {μ}_{dist} \vert < 2 {σ}_{dist} or \vert {θ}_{l} - {μ}_{angle} \vert < 2 {σ}_{angle} \\ i ∉ {I}_{inlier} & otherwise\end{matrix} \qquad [ Equation 2 ]$$

In order to remove an error, the Outlier remover 12 may apply a constraint on disparity size and angle of a corresponding pair of feature points to a size (Dᵢ) of disparity and an angle (θᵢ) of disparity for each corresponding pair of feature points. For example, the Outlier remover 12 may confirm an average (μ_{dist}) and a standard deviation (σ_{dist}) for an overall disparity size and calculate an average (μ_{angle}) and a standard deviation (σ_{angle}) for disparity angle so that it may determine values of disparity size and angle twice or more the standard deviation for the average as error values and remove them.

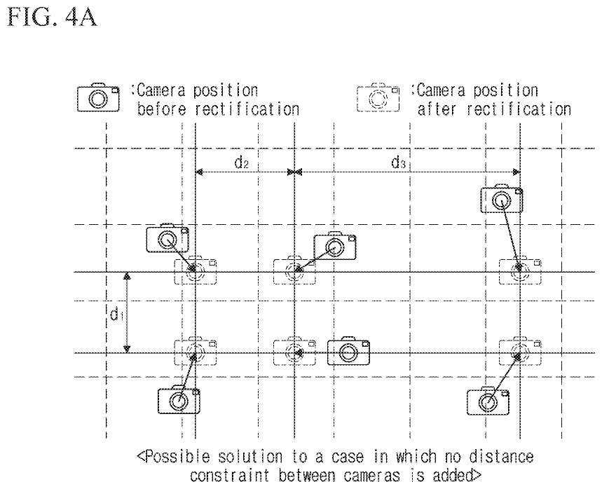

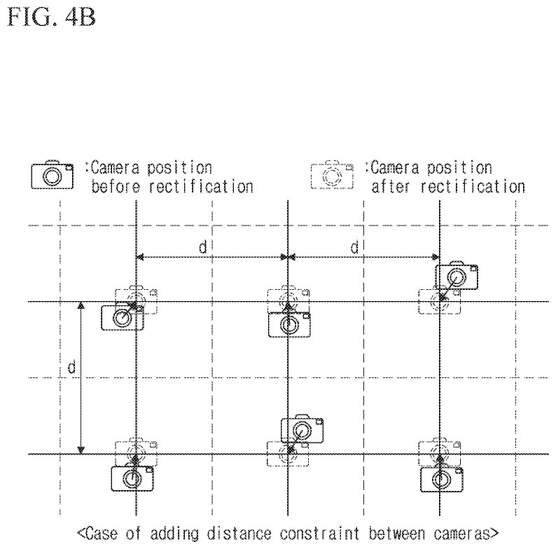

For corresponding pairs of feature points with errors being removed, the disparity error monitoring unit 13 detects a same number of corresponding pairs of feature points in each input image. The disparity error monitoring unit 13 may manage the detected corresponding pairs of feature points by considering an arrangement relationship of input images. As input images may be arranged vertically or horizontally, the disparity error monitoring unit 13 may manage corresponding pairs by including information for identifying whether or not a corresponding pair of feature points is in a vertical direction or in a horizontal direction. A management operation for a corresponding pair of feature points will be described in detail with reference to FIG. 4A and FIG. 4B.

In addition, in order to modify an ultimately rectified image to be like an image taken by parallel cameras a same internal parameter, the disparity error monitoring unit 13 may assume a common rectification matrix and a rectifying internal parameter and construct a projection matrix by referring to an internal/external parameter Ki and [Rᵢ tᵢ] of a given camera. Specifically, the disparity error monitoring unit may construct a projection matrix considering a camera configuration and rectify a disparity error by applying a feature point to a projection matrix. Herein, when an internal/external parameter of the camera i is Kᵢ and [Rᵢtᵢ] is given, a common rectification matrix (\hat{R}ₜ) and a rectifying internal parameter (R₁) may be defined, and a projection matrix (Hi) for each input image may be constructed as shown in Equation 3 below.

$${H}_{i} = {\hat{K}}_{i} , {[ {\hat{R}}_{i} {R}_{1} \vert - {\hat{R}}_{i} ( {t}_{i} + {\hat{t}}_{i} ) ] [ {R}_{i} \vert {R}_{i} {t}_{i} ]}^{+} {K}_{i}^{- 1} \\ {\hat{K}}_{i} = [ \begin{matrix}α & 0 & w / 2 \\ 0 & α & h / 2 \\ 0 & 0 & 1\end{matrix} ] , \\ {\hat{R}}_{i} = [ \begin{matrix}cos {θ}_{1} & - sin {θ}_{1} & 0 \\ sin {θ}_{1} & cos {θ}_{1} & 0 \\ 0 & 0 & 1\end{matrix} ] [ \begin{matrix}cos {θ}_{2} & 0 & sin {θ}_{2} \\ 0 & 1 & 0 \\ - sin {θ}_{2} & 0 & cos {θ}_{2}\end{matrix} ] [ \begin{matrix}1 & 0 & 0 \\ 0 & cos {θ}_{3} & - sin {θ}_{3} \\ 0 & sin {θ}_{3} & cos {θ}_{3}\end{matrix} ] \qquad [ Equation 3 ]$$

a is a parameter for rectifying a focal distance of image, θ₁, θ₂, and θ₃ are parameters for rectifying a common rotating position of camera, \hat{R}ₜ represents a common rectifying rotation 1 5 matrix, and R₁ represents a rectifying internal parameter. [symbol] represents a rectifying translation vector of each camera.

As a rectified parameter value shows a degree of change from a physical position of an actual camera, a projection matrix expressing it is constraint for projection onto a common plane reflecting positions of actual cameras.

Moreover, a difference of a projected coordinate pair in a vertical direction is a y-axis disparity, and a disparity between y-axis corresponding pairs is a y-axis disparity error (or vertical disparity error). Also, a coordinate difference in a horizontal direction is an x-axis disparity, and a disparity between x-axis corresponding pairs is an x-axis disparity error (or horizontal disparity error). In order to minimize x-axis and y-axis disparity errors, the disparity error monitoring unit 13 may calculate a sum of disparity errors of each axis as an overall disparity error. For example, the disparity error monitoring unit 13 may produce a disparity error for input images, which are arranged in two dimensions, through the calculation of Equation 4.

$$e = {\sum }_{p = 1}^{\vert P \vert} {\sum }_{q = 1}^{\vert Q \vert - 1} \text{?} {\vert {( {{H}_{p , q} ( {f}_{( p , q ) , ( p , q + 1 )}^{k} )}^{( p , q )} )}_{y} - {( {{H}_{p , q + 1} ( {f}_{( p , q ) , ( p , q + 1 )}^{k} )}^{( p , q + 1 )} )}_{y} \vert}^{2} + {\sum }_{p = 1}^{\vert P \vert} {\sum }_{q = 1}^{\vert Q \vert - 1} \text{?} {\vert {( {{H}_{p , q} ( \text{?} )}^{( p , q )} )}_{x} - {( \text{?} {( \text{?} )}^{( p , q + 1 , q )} )}_{x} \vert}^{2} \\ \text{?} \text{indicates text missing or illegible when filed} \qquad [ Equation 4 ]$$

H_{p,q} represents a projection matrix of an input image corresponding to nth row and q-th column, F_{(p,q),(w,r)} represents a set of feature points that are commonly detected between a first input image (p, q) and a second input image (w, r), and (f^{k}_{(p,q),(w,r)})^{(p,q)} represents k-th element of F_{(i,j),(w,r)}in the first input image (p, q).

Furthermore, when a physical position of a camera (e.g, a baseline between cameras) known, image rectification may be implemented more accurately. For example, as illustrated in FIG. 4A, when a physical position of a camera (e.g., a baseline between cameras) is not accurately identified, input images may be considered as images obtained from cameras on a same plane, but a rectified distance between cameras may be different from a physical distance between actual cameras. In order to realize image rectification more accurately, a position between cameras needs to be set to be the same as a physical distance between actual cameras. For example, as illustrated in FIG. 4B, when constraining a physical position of a camera, positions of cameras may be set to be the same as a physical distance between actual cameras,

In consideration of what is described above, the disparity error monitoring unit 13 constrains a distance between camera positions to maintain it as a value calculated through Equation 5 below.

$${D}_{constraint} = {\sum }_{i = 1}^{\# of Camera} {\sum }_{j ∈ {u}_{1}} abs ( {‖ ( {t}_{i} + \hat{{t}_{i}} ) - ( {t}_{j} + \hat{{t}_{j}} ) ‖}_{2} - d ) \\ d = \frac{{\sum }_{i = 1}^{\# of Camera} \frac{{\sum }_{j ∈ {u}_{1}} abs ( {‖ ( {t}_{i} + \hat{{t}_{i}} ) - ( {t}_{j} + \hat{{t}_{j}} ) ‖}_{2} )}{\vert {U}_{i} \vert}}{\# of camera} \qquad [ Equation 5 ]$$

Uᵢ is a set of cameras adjacent to i-th camera, and d means an average camera distance after rectification. D_{constraint} means a distance parity between newly rectified cameras.

Consequently, the disparity error monitoring unit 13 may produce an ultimate disparity error (E) by adding a distance parity between cameras (D_{constraint}) to the above-described disparity error (e). That is, the disparity error monitoring unit 13 may produce an ultimate disparity error (E) through the calculation of Equation 6 below.

E=e+D_{constraint} [Equation 6]

When considering a newly projected plane, a projection matrix Hᵢ to be obtained should be transformation into an image plane in which there is no y-axis disparity error between feature points of image obtained from a same row and there is no x-axis disparity error between feature points of image obtained from a same column. In addition, as a transform matrix is sought which may maintain a relative distance between cameras suitably for an ideal 2D camera structure, a distance disparity (D_{constraint}) between cameras is minimized so that a distance between each camera is maintained while minimizing a disparity error (e). In consideration of what is described above, in order to find a parameter capable of minimizing a final disparity error, the disparity error monitoring unit 13 may iteratively perform an operation of calculating a disparity error (e) and a distance parity (D_{constraint}) between cameras until finding a parameter minimizing an objective function defined by a nonlinear optimization method.

Meanwhile, the image rectifier 14 may perform warping for input images by using a projection matrix that is determined in the disparity error monitoring unit 13 and may perform rectification of an input image that is corrected through warping.

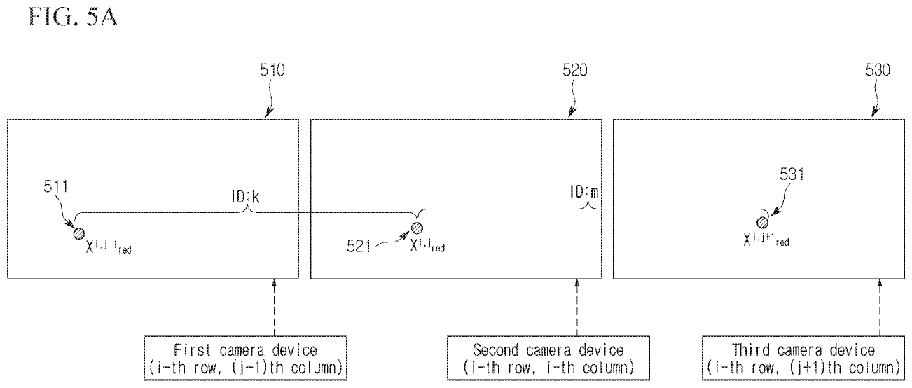

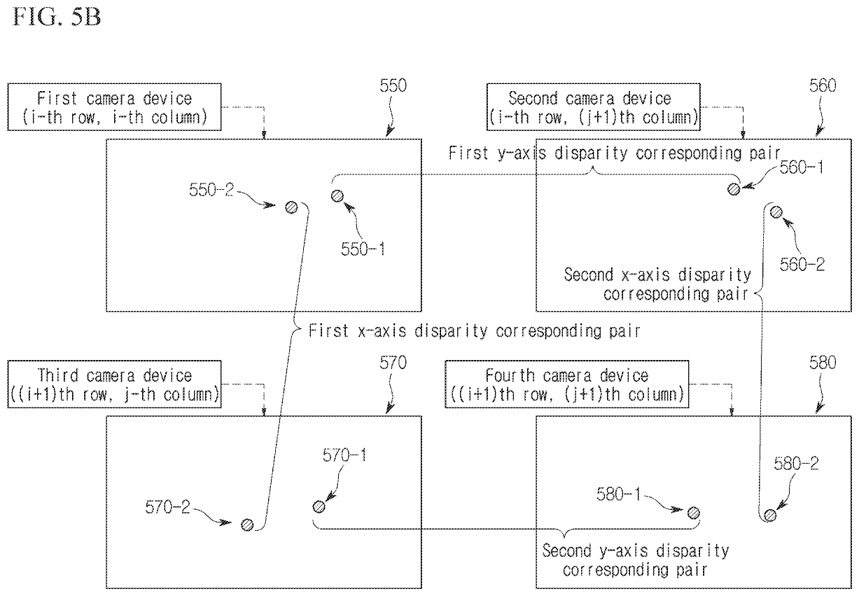

FIG. 5A and FIG. 5B are views illustrating corresponding pairs of feature points that are managed by a rectification apparatus of 2D multi-view images according to an embodiment of the present disclosure.

First, referring to FIG. 5A, first to third input images 510, 520 and 530 are sequentially arranged in horizontal direction and are images that are taken by first to third camera devices sequentially arranged in horizontal direction respectively. The second camera device may be a camera device provided at a position of i-th row and j-th column, the first camera device may be a camera device that is on the left side of the second camera device and is provided at a position of i-th row and (j−1)th column, and the third camera device may be a camera device that is on the right side of the second camera device and is provided at a position of i-th row and (j+1)th column.

The first to third input images 510, 520 and 530 may have first to third feature points 511, 521 and 531 respectively, and the first to third feature points 511, 521 and 531 may be corresponding pairs. The first to third feature points 511, 521 and 531 may be feature points that exist at positions of X^{i,j-1}_{red}, X^{i,j}_{red} and X^{i,j+1}_{red}, respectively. In such an environment, a rectification apparatus of 2D multi-view images, especially the disparity error monitoring unit 13 may give different identifiers for a same feature point, which is used for different corresponding pairs between input images, and manage the corresponding pairs. Specifically, the disparity error monitoring unit 13 may determine the first feature point 511 and the second feature point 521 as a corresponding pair and manage the pair by setting it as k-th corresponding pair (ID:k, [X^{i,j-1}_{red}, X^{i,j}_{red}]) and may determine the second feature point 521 and the third feature point 531 as a corresponding pair and manage the pair by setting it as m-th corresponding pair (ID:m, [X^{i,j}_{red}, X^{i,j+1}_{red}]).

Meanwhile, referring to FIG. 5B, first to fourth input images 550, 560, 570 and 580 are two-dimensionally arranged in horizontal and vertical directions, and the first to fourth input images 550, 560, 570 and 580 may be images taken by camera devices that are two-dimensionally arranged in horizontal and vertical directions. A first camera device may be a camera device provided at a position of i-th row and j-th column, a second camera device may be a camera device that is on the left side of the first camera device and is provided at a position of i-th row and (j+1)th column, a third camera device may be a camera device that is under the first camera device and is provided at a position of (i+1)th row and j-th column, and a fourth camera device may be a camera device that is on the right side of the third camera device and is provided at a position of (i+1)th row and (j+1)th column.

Also, it is illustrated that the first input image 550 has a 1-1th feature point 550-1 and a 1-2th feature point 550-2, the second input image 560 has a 2-1th feature point 560-1 and a 2-2th feature point 560-2, the third feature point 570 has a 3-1th feature point 570-1 and a 3-2th feature point 570-2, and the fourth input image has a 4-1th feature point 580-1 and a 4-2th feature point 580-2. Thus, when the first to fourth input images 550, 560, 570 and 580 are arranged in two dimensions, the disparity error monitoring unit 13 may classify the feature points into corresponding pairs of feature points obtained from a same column and corresponding pairs of feature points obtained from a same row and manage the feature points. That is, the disparity error monitoring unit 13 may determine and manage the 1-1th feature point 550-1 and the 2-1th feature point 560-1 of the first and second input images 550 and 560, which are horizontally arranged, as a first y-axis disparity corresponding pair, and may determine and manage the 3-1th feature point 570-1 and the 4-1th feature point 580-1 of the third and fourth input images 570 and 580 as a second y-axis disparity corresponding pair. Also, the disparity error monitoring unit 13 may determine and manage the 1-2th feature point 550-2 and the 3-2th feature point 570-2 of the first and third input images 550 and 570, which are vertically arranged, as a first x-axis disparity corresponding pair, and may determine and manage the 2-2th feature point 560-2 and the 4-2th feature point 580-2 of the second and fourth input images 560 and 580 as a second x-axis disparity corresponding pair.

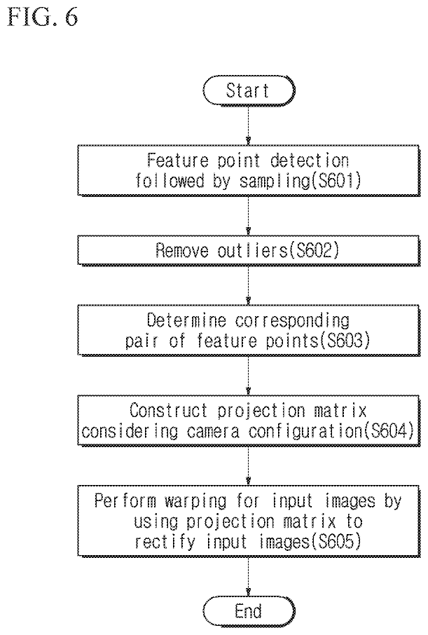

FIG. 6 is a flowchart illustrating an order in a method for rectifying 2D multi-view images according to an embodiment of the present disclosure.

A rectification method of 2D multi-view images according to an embodiment of the present disclosure may be performed by the above-described rectification apparatus of 2D multi-view images (hereinafter, referred to as “image rectification apparatus”).

First, in the step S601, an image rectification apparatus may detect at least one feature point from each of a plurality of input images. Herein, a plurality of input images may be images that are obtained from each of a plurality of cameras. Feature point detection may be performed based on the speed-up robust feature (SURF) method. For example, the image rectification apparatus may construct an integral image through an operation of Equation 1 described above and may detect a feature point by calculating an extreme value through a Hessian matrix for an integral image. Although an embodiment of the present disclosure illustrates a method for detecting a feature point, the present disclosure is not limited to the embodiment and the method for detecting a feature point may be modified in various ways.

Especially, the image rectification apparatus may detect uniformly feature points in a plurality of regions by considering a distribution of feature points in an input image. Specifically, the image rectification apparatus may perform sampling so that feature points detected in an input image are distributed uniformly in an image. As described above, as the feature points 210 are detected based on an extreme value of an image, they may be distributed locally intensively in a specific region of the input image 200. When considering only feature points that are locally intensively distributed in an input image, different rectification errors may occur according to a distribution of feature points. In order to improve this, an image rectification apparatus needs to process so that feature points are uniformly distributed over a whole area of image. In this regard, in order to select uniformly some of the detected feature points 210 in an image, the image rectification apparatus may split the input image 200 into predetermined regions using a partitioning algorithm (e.g., k-d tree algorithm) and then may sample a predetermined number of feature points in each of the split regions 201, 202, 203 and 204. For example, the image rectification apparatus may divide an input image into preset M regions sequentially from a point with a largest disparity based on detected feature points, detect each feature point in the split regions 201, 202, 203 and 204 respectively, and finally detect M feature points that are uniformly distributed.

In the step S602, the image rectification apparatus may confirm whether feature points correspond to each other between input images (e.g., input images obtained from neighboring cameras) in which an overlap occurs at least for some regions. For example, the image rectification apparatus may construct a corresponding pair of feature points using feature points detected in a uniform distribution and perform an operation of removing an error or outlier of corresponding pairs through the operation of Equation 2 described above.

In order to remove an error, the image rectification apparatus may apply a constraint on disparity size and angle of a corresponding pair of feature points to a size (Dᵢ) of disparity and an angle (θᵢ) of disparity for each corresponding pair of feature points. For example, the image rectification apparatus may confirm an average (μ_{dist}) and a standard deviation (σ_{dist}) for an overall disparity size and calculate an average (μ_{angle}) and a standard deviation (σ_{angle}) for disparity angle so that it may determine values of disparity size and angle twice or more the standard deviation for the average as error values and remove them.

In the step S603, for corresponding pairs of feature points with errors being removed, the image rectification apparatus detects a same number of corresponding pairs of feature points in each input image. Herein, the image rectification apparatus may manage the detected corresponding pairs of feature points by considering an arrangement relationship of input images. As input images may be arranged vertically or horizontally, the image rectification apparatus may manage corresponding pairs by including information for identifying whether or not a corresponding pair of feature points is in a vertical direction or m a horizontal direction.

For example, referring to FIG. 5A, the first to third input images 510, 520 and 530 are sequentially arranged in horizontal direction and are images that are taken by first to third camera devices sequentially arranged in horizontal direction respectively. The second camera device may be a camera device provided at a position of i-th row and j-th column, the first camera device may be a camera device that is on the left side of the second camera device and is provided at a position of i-th row and (j−1)th column, and the third camera device may be a camera device that is on the right side of the second camera device and is provided at a position of i-th row and (j+1)th column. The first to third input images 510, 520 and 530 may have first to third feature points 511, 521 and 531 respectively, and the first to third feature points 511, 521 and 531 may be corresponding pairs. The first to third feature points 511, 521 and 531 may be feature points that exist at positions of X^{i,j-1}_{red}, X^{i,j}_{red} and X^{i,j+1}_{red}, respectively. In such an environment, an image rectification apparatus may give different identifiers for a same feature point, which is used for different corresponding pairs between input images, and manage the corresponding pairs. Specifically, an image rectification apparatus may determine the first feature point 511 and the second feature point 521 as a corresponding pair and manage the pair by setting it as k-th corresponding pair (ID:k, [X^{i,j-1}_{red}, X^{i,j}_{red} ]) and may determine the second feature point 521 and the third feature point 531 as a corresponding pair and manage the pair by setting it as m-th corresponding pair (ID:m, [X^{i,j}_{red}, X^{i,j+1}_{red}]).

Also, referring to FIG. 5B, the first to fourth input images 550, 560, 570 and 580 are two-dimensionally arranged in horizontal and vertical directions, and the first to fourth input images 550, 560, 570 and 580 may be images taken by camera devices that are two-dimensionally arranged in horizontal and vertical directions. A first camera device may be a camera device provided at a position of i-th row and j-th column, a second camera device may be a camera device that is on the left side of the first camera device and is provided at a position of i-th row and (j+1)th column, a third camera device may be a camera device that is under the first camera device and is provided at a position of (i+1)th row and j-th column, and a fourth camera device may be a camera device that is on the right side of the third camera device and is provided at a position of (i+1)th row and (j+1)th column. Also, it is illustrated that the first input image 550 has a 1-1th feature point 550-1 and a 1-2th feature point 550-2, the second input image 560 has a 2-1th feature point 560-1 and a 2-2th feature point 560-2, the third feature point 570 has a 3-1th feature point 570-1 and a 3-2th feature point 570-2, and the fourth input image has a 4-1th feature point 580-1 and a 4-2th feature point 580-2. Thus, when the first to fourth input images 550, 560, 570 and 580 are arranged in two dimensions, an image rectification apparatus may classify the feature points into corresponding pairs of feature points obtained from a same column and corresponding pairs of feature points obtained from a same row and manage the feature points. That is, an image rectification apparatus may determine and manage the 1-1th feature point 550-1 and the 2-1th feature point 560-1 of the first and second input images 550 and 560, which are horizontally arranged, as a first y-axis disparity corresponding pair, and may determine and manage the 3-1th feature point 570-1 and the 4-1th feature point 580-1 of the third and fourth input images 570 and 580 as a second y-axis disparity corresponding pair. Also, an image rectification apparatus may determine and manage the 1-2th feature point 550-2 and the 3-2th feature point 570-2 of the first and third input images 550 and 570, which are vertically arranged, as a first x-axis disparity corresponding pair, and may determine and manage the 2-2th feature point 560-2 and the 4-2th feature point 580-2 of the second and fourth input images 560 and 580 as a second x-axis disparity corresponding pair.

Meanwhile, in order to modify an ultimately rectified image to be like an image taken by parallel cameras with a same internal parameter, an image rectification apparatus may assume a common rectification matrix and a rectifying internal parameter and construct a projection matrix by referring to an internal/external parameter Ki and [Rᵢ tᵢ] of a given camera. Thus, to rectify an input image, an image rectification apparatus may construct a projection matrix considering a camera configuration (S604).

Specifically, an image rectification apparatus may rectify a disparity error by applying a feature point to a projection matrix. Herein, when an internal/external parameter of the camera i is Kᵢ and [Rᵢtᵢ] is given, a common rectification matrix (\hat{R}ₜ) and a rectifying internal parameter (R₁) may be defined, and a projection matrix (Hi) for each input image may be constructed as shown in Equation 2 described above. As a rectified parameter value shows a degree of change from a physical position of an actual camera, a projection matrix expressing it is constraint for projection onto a common plane reflecting positions of actual cameras. Moreover, a difference of a projected coordinate pair in a vertical direction is a y-axis disparity, and a disparity between y-axis corresponding pairs is a y-axis disparity error (or vertical disparity error). Also, a coordinate difference in a horizontal direction is an x-axis disparity, and a disparity between x-axis corresponding pairs is an x-axis disparity error (or horizontal disparity error). In order to minimize x-axis and y-axis disparity errors, an image rectification apparatus may calculate a sum of disparity errors of each axis as an overall disparity error. For example, an image rectification apparatus may produce a disparity error for input images, which are arranged in two dimensions, through the calculation of Equation 3 described above. When a physical position of a camera (e.g, a baseline between cameras) is known, image rectification may be implemented more accurately. For example, as illustrated in FIG. 4A, when a physical position of a camera (e.g., a baseline between cameras) is not accurately identified, input images may be considered as images obtained from cameras on a same plane, but a rectified distance between cameras may be different from a physical distance between actual cameras. In order to realize image rectification more accurately, a position between cameras needs to be set to be the same as a physical distance between actual cameras. For example, as illustrated in FIG. 4B, when constraining a physical position of a camera, positions of cameras may be set to be the same as a physical distance between actual cameras. In consideration of what is described above, an image rectification apparatus constrains a distance between camera positions to maintain it as a value calculated through Equation 4 described above. Consequently, an image rectification apparatus may produce an ultimate disparity error (E) by adding a distance parity between cameras (D_{constraint}) to the above-described disparity error (e).

When considering a newly projected plane, a projection matrix Hᵢ to be obtained should be transformation into an image plane in which there is no y-axis disparity error between feature points of image obtained from a same row and there is no x-axis disparity error between feature points of image obtained from a same column. In addition, as a transform matrix is sought which may maintain a relative distance between cameras suitably for an ideal 2D camera structure, a distance disparity (D_{constraint}) between cameras is minimized so that a distance between each camera is maintained while minimizing a disparity error (e). In consideration of what is described above, in order to find a parameter capable of minimizing a final disparity error, an image rectification apparatus may iteratively perform an operation of calculating a disparity error (e) and a distance parity (D_{constraint}) between cameras until finding a parameter minimizing an objective function defined by a nonlinear optimization method.

Meanwhile, an image rectification apparatus may perform warping for input images by using a projection matrix that is determined through the above-described operation, and may perform rectification of an input image that is corrected through warping (S605).

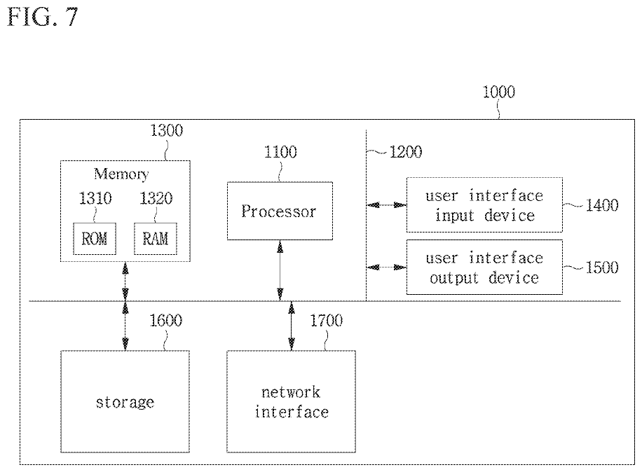

FIG. 7 is a block diagram illustrating a computing system implementing a method and apparatus for rectifying 2D multi-view images according to an embodiment of the present disclosure.

Referring to FIG. 7, a computing system 100 may include at least one processor 1100 connected through a bus 1200, a memory 1300, a user interface input device 1400, a user interface output device 1500, a storage 1600, and a network interface 1700.

The processor 1100 may be a central processing unit or a semiconductor device that processes commands stored in the memory 1300 and/or the storage 1600. The memory 1300 and the storage 1600 may include various volatile or nonvolatile storing media. For example, the memory 1300 may include a ROM (Read Only Memory) and a RAM (Random Access Memory).

Accordingly, the steps of the method or algorithm described in relation to the embodiments of the present disclosure may be directly implemented by a hardware module and a software module, which are operated by the processor 1100, or a combination of the modules. The software module may reside in a storing medium (that is, the memory 1300 and/or the storage 1600) such as a RAM memory, a flash memory, a ROM memory, an EPROM memory, an EEPROM memory, a register, a hard disk, a detachable disk, and a CD-RUM. The exemplary storing media are coupled to the processor 1100 and the processor 1100 can read out information from the storing media and write information on the storing media. Alternatively, the storing media may be integrated with the processor 1100. The processor and storing media may reside in an application specific integrated circuit (ASIC). The ASIC may reside in a user terminal. Alternatively, the processor and storing media may reside as individual components in a user terminal.

The exemplary methods described herein were expressed by a series of operations for clear description, but it does not limit the order of performing the steps, and if necessary, the steps may be performed simultaneously or in different orders. In order to achieve the method of the present disclosure, other steps may be added to the exemplary steps, or the other steps except for some steps may be included, or additional other steps except for some steps may be included.

Various embodiments described herein are provided to not arrange all available combinations, but explain a representative aspect of the present disclosure and the configurations about the embodiments may be applied individually or in combinations of at least two of them.

Further, various embodiments of the present disclosure may be implemented by hardware, firmware, software, or combinations thereof. When hardware is used, the hardware may be implemented by at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), a general processor, a controller, a micro controller, and a micro-processor.

The scope of the present disclosure includes software and device-executable commands (for example, an operating system, applications, firmware, programs) that make the method the various embodiments of the present disclosure executable on a machine or a computer, and non-transitory computer-readable media that keeps the software or commands and can be executed on a device or a computer.

What is claimed is:

1. A method for rectifying a 2D multi-view image, the method comprising:
detecting uniformly at least one feature point in each region unit distinguished by considering a distribution of feature points of a plurality of input images;
removing an error of the least one feature point;
determining a corresponding pair for a vertical or horizontal direction of the at least one feature point;
by considering an arrangement relationship of the plurality of input images, projecting the at least one feature point onto a projection plane;
determining a disparity error for a corresponding pair for the at least one feature point that is projected onto the projection plane; and
by considering the disparity error, performing image rectification based on the at least one feature point.

2. The method of claim 1,
wherein the determining of the corresponding pair for the vertical or horizontal direction of the at least one feature point comprises:
by considering the arrangement relationship of the plurality of input images, determining a corresponding relationship of the vertical or horizontal direction, and
based on the corresponding relationship, determining a corresponding pair for the vertical or horizontal direction.

3. The method of claim 1,
wherein the projecting of the at least one feature point onto the projection plane comprises:
determining at least one projection matrix, and
constructing coordinate information on the projection plane by applying the at least one projection matrix to each of a plurality of input images.

4. The method of claim 3,
wherein the determining of the disparity error comprises determining, by considering the coordinate information on the projection plane, a disparity error for the vertical or horizontal direction.

5. The method of claim 3,
wherein the determining of the disparity error comprises rectifying, by considering the coordinate information on the projection plane, a position of a camera taking at least one of the plurality of input images.

6. The method of claim 5,
wherein the determining of the disparity error comprises minimizing a final disparity error by reflecting the disparity error for the vertical or horizontal direction and the rectified position of the camera.

7. An apparatus for rectifying a 2D multi-view image, the apparatus comprising:
a feature point detection unit configured to uniformly detect at least one feature point in each region unit distinguished by considering a distribution of feature points of a plurality of input images;
an Outlier remover configured to remove an outlier of the least one feature point;
a disparity error monitoring unit configured to confirm a corresponding pair for a vertical or horizontal direction of the at least one feature point and to confirm a disparity error for a corresponding pair for the at least one feature point, which is projected onto a projection plane, by considering an arrangement relationship of the plurality of input images; and
an image rectifier configured to perform image rectification based on the at least one feature point by considering the disparity error.

8. The apparatus of claim 7,
wherein the disparity error monitoring unit confirms a corresponding relationship of the vertical or horizontal direction and, based on the corresponding relationship, determines a corresponding pair for the vertical or horizontal direction.

9. The apparatus of claim 7,
wherein the disparity error monitoring unit confirms at least one projection matrix and constructs coordinate information on the projection plane by applying the at least one projection matrix to each of a plurality of input images.

10. The apparatus of claim 9,
wherein the disparity error monitoring unit confirms a disparity error for the vertical or horizontal direction b considering the coordinate information on the projection plane.

11. The apparatus of claim 9,
wherein the disparity error monitoring unit rectifies a position of a camera taking at least one of the plurality of input images by considering the coordinate information on the projection plane.

12. The apparatus of claim 11,
wherein the disparity error monitoring unit rectifies a final disparity error by reflecting the disparity error for the vertical or horizontal direction and the rectified position of the camera.
